(19) United States
(12) Patent Application Publication
(10) Pub. No.: US 2012/0155835 A1
(43) Pub. Date: Jun. 21, 2012

(54) APPARATUS AND METHOD FOR GENERATING HARMFULNESS MAPS

(75) Inventor: Jae-Deok LIM, Daejeon (KR)

(73) Assignee: Electronics and Telecommunications Research Institute, Daejeon-city (KR)

(21) Appl. No.: 13/300,226

(22) Filed: Nov. 18, 2011

(30) Foreign Application Priority Data
Dec. 15, 2010 (KR) 10-2010-0128643

(51) Int. Cl. H04N 9/80

(52) U.S. Cl. 386/241; 386/E09.011

(57) ABSTRACT

Disclosed herein are an apparatus and method for generating harmfulness maps. The apparatus includes a harmfulness determination unit and a harmfulness map creation unit. The harmfulness determination unit generates harmfulness determination information by determining the degrees of harmfulness of some sections of multimedia content based on the time of playback of the multimedia content. The harmfulness map creation unit generates a harmfulness map of the multimedia content by marking the harmfulness determination information of the sections in a time sequence in graphical information form.

### CROSS REFERENCE TO RELATED APPLICATION

This application claims the benefit of Korean Patent Application No. 10-2010-0128643, filed on Dec. 15, 2010, which is hereby incorporated by reference in its entirety into this application.

### BACKGROUND OF THE INVENTION

1. Technical Field

The present invention relates generally to an apparatus and method for generating harmfulness maps and, more particularly, to an apparatus and method for generating harmfulness maps, which can generate a harmfulness map on which information about the sections of multimedia content corresponding to harmful content and information about the sections of the multimedia content corresponding to harmless content are marked in graphical information form, thereby clearly presenting information about the harmful sections and degrees of harmfulness of the multimedia content and facilitating the management and editing of the harmful sections.

2. Description of the Related Art

Recently, with the popularization of the wired and/or wireless Internet, the range of ages of users who use the Internet is gradually widening, and the numbers of times that Internet information is utilized are increasing across various fields, including companies, schools, and homes.

Accordingly, an immense amount of multimedia content is rapidly spreading over the wired and/or wireless Internet. However, among such pieces of multimedia content, there are many pieces of multimedia content that include harmful information containing sexual expressions or violent content. Furthermore, the unrestricted spread of such harmful multimedia content is exerting a bad influence on children or juveniles.

Although conventional methods of automatically blocking multimedia content containing harmful information or deleting parts of multimedia content containing harmful information have been used, there arises the problem that harmless multimedia content is also blocked due to the inaccuracy of the determination of harmful information or the problem that harmless information is erroneously deleted.

### SUMMARY OF THE INVENTION

Accordingly, the present invention has been made keeping in mind the above problems occurring in the prior art, and an object of the present invention is to provide an apparatus and method for generating harmfulness maps, which can generate a harmfulness map on which information about the sections of multimedia content corresponding to harmful content and information about the sections of the multimedia content corresponding to harmless content are marked in graphical information form, thereby clearly presenting information about the harmful sections and degrees of harmfulness of the multimedia content and facilitating the management and editing of the harmful sections.

In order to accomplish the above object, the present invention provides an apparatus for generating harmfulness maps, including a harmfulness determination unit for generating harmfulness determination information by determining the degrees of harmfulness of some sections of multimedia content based on the time of playback of the multimedia content; and a harmfulness map creation unit for generating a harmfulness map of the multimedia content by marking the harmfulness determination information of the sections in a time sequence in graphical information form.

The graphical information may be color information in which colors including red R, green G and blue B have been combined with one another.

In order to accomplish the above object, the present invention provides a method of generating harmfulness maps, including dividing multimedia content into a plurality of sections; generating harmfulness determination information by determining degrees of harmfulness of some of the plurality of sections; and generating a harmfulness map of the multimedia content by marking the harmfulness determination information of the sections in a time sequence in graphical information form.

The graphical information may be color information in which colors including red R, green G and blue B have been combined with one another.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically illustrating the concept of generating a harmfulness map using an apparatus for generating harmfulness maps according to an embodiment of the present invention;

FIG. 2 is a diagram schematically illustrating the apparatus for generating harmfulness maps according to the embodiment of the present invention;

FIG. 3 is a diagram schematically illustrating a two-category harmfulness map that is generated by the apparatus for generating harmfulness maps according to the embodiment of the present invention;

FIG. 4 is a diagram schematically illustrating the configuration of graphical information that may be used for the apparatus for generating harmfulness maps according to the embodiment of the present invention;

FIG. 5 is a diagram schematically illustrating a probability-based multi-category harmfulness map that is generated by the apparatus for generating harmfulness maps according to the embodiment of the present invention; and

FIG. 6 is a flowchart illustrating a flowchart illustrating a method of generating harmfulness maps according to an embodiment of the present invention.

### DESCRIPTION OF THE PREFERRED EMBODIMENTS

Reference now should be made to the drawings throughout which the same reference numerals are used to designate the same or similar components.

The present invention will be described in detail below with reference to the accompanying drawings. Repetitive descriptions and descriptions of known functions and constructions which have been deemed to make the gist of the present invention unnecessarily vague will be omitted below. The embodiments of the present invention are provided in order to fully describe the present invention to a person having ordinary skill in the art. Accordingly, the shapes, sizes, etc. of elements in the drawings may be exaggerated to make the description clear.

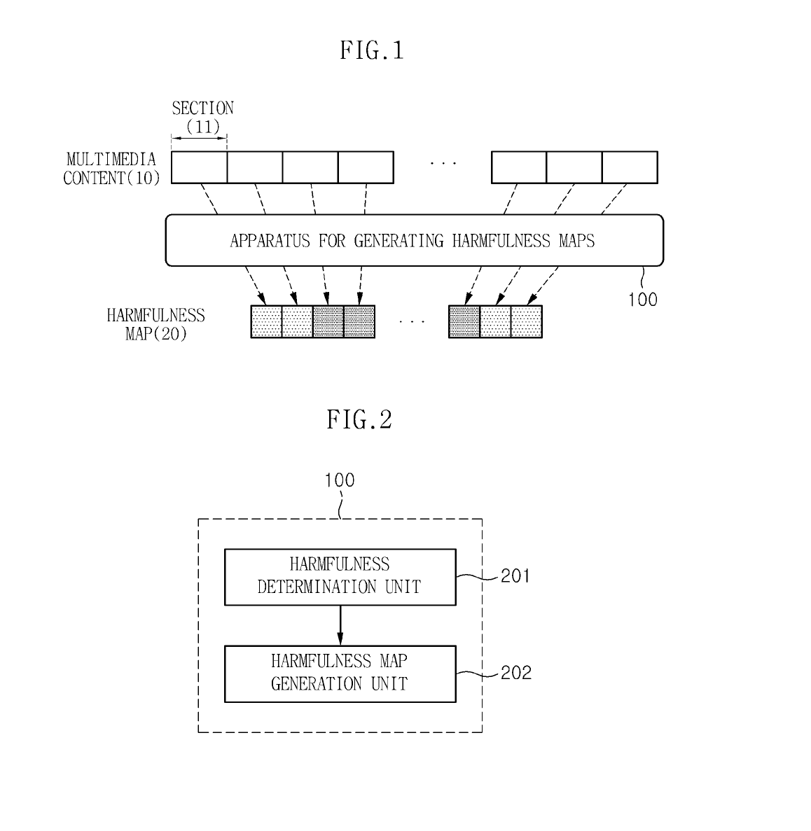

FIG. 1 is a diagram schematically illustrating the concept of generating a harmfulness map using an apparatus for generating harmfulness maps according to an embodiment of the present invention.

Referring to FIG. 1, in the upper portion thereof, multimedia content 10 is arranged in a time sequence. The multimedia content 10 may be divided into a plurality of sections 11 based on the time of playback of the multimedia content 10. The leftmost section is the section where the multimedia content 10 starts, while the rightmost section is the section where the multimedia content 10 ends. Information about these sections is input to the apparatus 100 for generating harmfulness maps, harmfulness determination information is generated by determining the degrees of harmfulness, and the harmfulness determination information is marked in the form of graphical information in a time sequence, thereby generating the harmfulness map 20 of the multimedia content 10. The graphical information may be color information, in which case the harmfulness map 20 may be a kind of color information bar-type map. The above-described harmfulness map 20 can show information about the configuration of the harmfulness of the corresponding multimedia content 10 in a simple form.

FIG. 2 is a diagram schematically illustrating the apparatus for generating harmfulness maps according to the embodiment of the present invention.

Referring to FIG. 2, the apparatus 100 for generating harmfulness maps according to the embodiment of the present invention may include a harmfulness determination unit 201, and a harmfulness map creation unit 202. The apparatus 100 for generating harmfulness maps shown in FIG. 2 is merely illustrative, and some elements may be modified, added, or deleted as necessary.

The harmfulness determination unit 201 generates harmfulness determination information by determining the degrees of harmfulness of some sections based on the time of playback of multimedia content. A variety of conventional methods were proposed as technology for determining the degrees of harmfulness using the harmfulness determination unit 201. The harmfulness determination unit 201 may determine the degrees of harmfulness using harmfulness determination technology including the above-described conventional methods. Here, the harmfulness determination unit 201 may generate harmfulness determination information by determining only the harmfulness of corresponding sections, or may generate harmfulness determination information corresponding to harmfulness determination probabilities indicative of the probabilities of determining that corresponding sections are harmful.

The harmfulness map creation unit 202 generates the harmfulness map of the multimedia content by marking the harmfulness determination information of the sections in a time sequence in the form of graphical information. Here, the graphical information is represented such that a user can easily understand the harmfulness information of the sections of the multimedia content. In an embodiment, the graphical information may be color information in which colors, including Red (R), Green (G) and Blue (B), have been combined with one another. In this case, the harmfulness map creation unit 202 may generate the harmfulness map by marking the harmfulness determination information as first color information if this section is harmful and marking the harmfulness determination information as second color information different from the first color information if this section is harmless. Although in an embodiment of the present invention, the first color information may be red and the second color information may be green, a user can determine the color information in various ways as necessary, and the present invention is not limited to the embodiment. For example, the first color information may be orange and the second color information may be blue.

In an embodiment, if the harmfulness determination information generated by the harmfulness determination unit 201 is based only on the determination of whether a corresponding section is harmful, the harmfulness map creation unit 202 marks the harmfulness determination information as first color information and the harmfulness determination information as second color information different from the first color information. Here, the harmfulness map generated by the harmfulness map creation unit 202 is a two-category harmfulness map. In this case, a user can easily determine whether each section of multimedia content is harmful or harmless.

In another embodiment, if the harmfulness determination information generated by the harmfulness determination unit 201 represents a harmfulness determination probability indicative of the probability of determining that a corresponding section is harmful, the harmfulness map creation unit 202 marks the harmfulness determination information corresponding to a high harmfulness determination probability, as high-saturation first color information, the harmfulness determination information corresponding to a moderate harmfulness determination probability (around 50%) as a color close to white, and a section having a low harmfulness determination probability using high-saturation second color information. In this case, the harmfulness map generated by the harmfulness map creation unit 202 is a probability-based multi-category harmfulness map. When graphical information is marked in various ways based on harmfulness determination probabilities, a user may reconsider each section of the harmfulness map having a low saturation, that is, a moderate harmfulness determination probability.

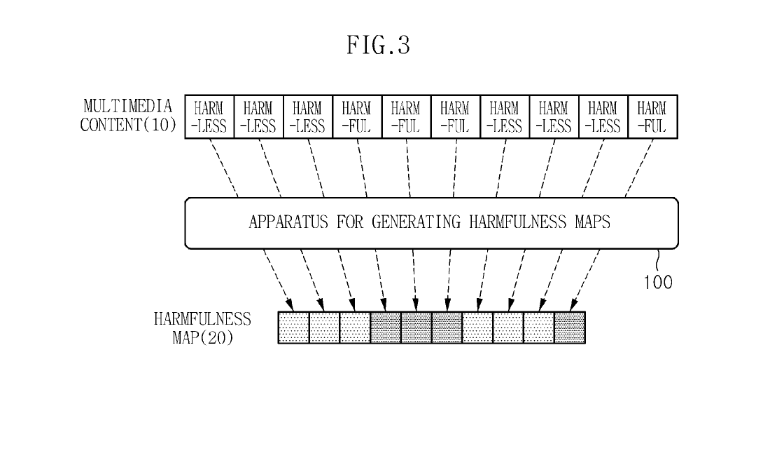

FIG. 3 is a diagram schematically illustrating a two-category harmfulness map that is generated by the apparatus for generating harmfulness maps according to the embodiment of the present invention.

As described above, in the apparatus for generating harmfulness maps according to the embodiment of the present invention, the harmfulness determination unit may generate harmfulness determination information by determining whether sections in the time of playback of the multimedia content are harmful, and the harmfulness map creation unit marks each harmful section using first color information and each harmless section using second color information. That is, a harmfulness map may be generated in the form of a two-category harmfulness map.

FIG. 3 shows a two-category harmfulness map generated by the apparatus for generating harmfulness maps 100 according to the above embodiment. In this case, it is assumed that multimedia content 10 is divided into ten sections. In the harmfulness map 20 of FIG. 3, a harmful section may be marked as combined color information of R=255, G=0 and B=0, that is, red, and harmless section may be marked as combined color information of R=0, G=255 and B=0, that is, green. Referring to the harmfulness map 20 of FIG. 3, it can be seen that the center portion and an end portion of the multimedia content presented using red are harmful portions. Using this information, appropriate filtering and management services may be provided.

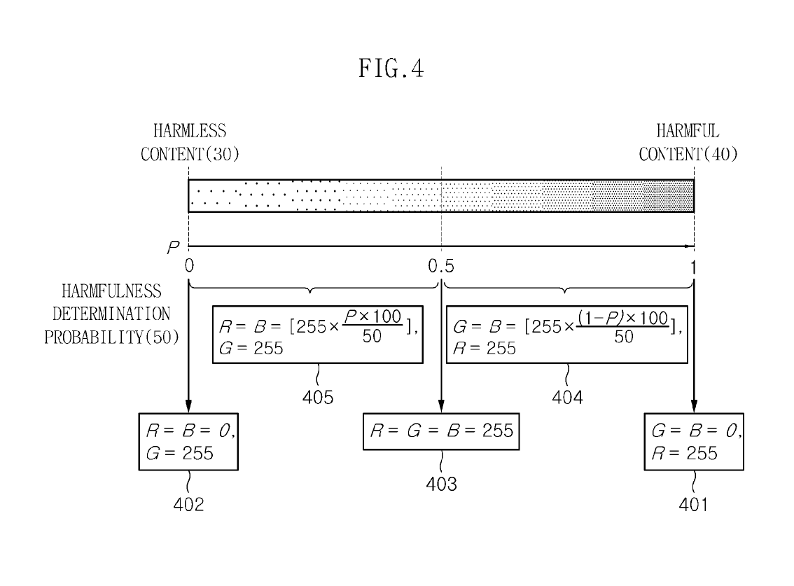

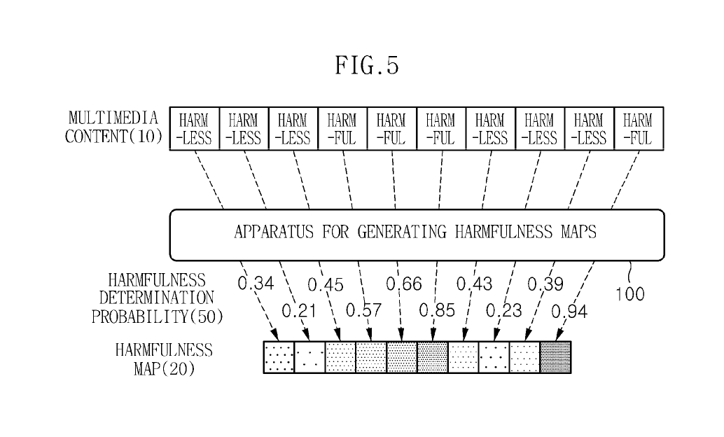

FIG. 4 is a diagram schematically illustrating the configuration of graphical information that may be used for the apparatus for generating harmfulness maps according to the embodiment of the present invention.

As described above, in the apparatus for generating harmfulness maps according to an embodiment of the present invention, the harmfulness determination unit may generate harmfulness determination information corresponding to the harmfulness determination probabilities of some sections based on the time of playback of the multimedia content, and the harmfulness map creation unit may mark each section having a high harmfulness determination probability using high-saturation first color information, a section having an intermediate harmfulness determination probability (around 50%) using a color close to white, and a section having a low harmfulness determination probability using high-saturation second color information.

Furthermore, assuming that the harmfulness determination probability of a section is p, if 50%<p<100%, the harmfulness map creation unit marks the harmfulness determination information as third color information having the same hue as the first color information and a saturation lower than that of the first color information, wherein the saturation of the third color information decreases as p decreases, and if 0%<p<50%, the harmfulness map creation unit marks the harmfulness determination information as fourth color information having the same hue as the second color information and a saturation lower than that of the second color information, wherein the saturation of the fourth color information decreases as p increases. That is, the harmfulness map may be a probability-based multi-category harmfulness map.

FIG. 4 illustrates the configuration of the graphical information that may be used in the above case. In a probability-based multi-category harmfulness map, harmfulness and harmlessness are determined based on probabilities. That is, assuming that the harmfulness determination probability is ‘p,’ when p is equal to or higher than 50%, it may be determined that a corresponding section is a harmful section, and probability information may also be provided. In this case, the probability may be marked as the saturation of a corresponding color. That is, an intermediate section is marked as white (R=G=B=255). As the harmfulness determination probability increases, the saturation of R is increased by adjusting G and B. In contrast, as the harmlessness determination probability increases, the saturation of G is increased by adjusting R and B. Using the above information, a manager may trust the results of the determination of a high-hue section, but may reexamine the results of the determination of a low-hue section, thereby reducing the errors of two-category determination.

Specifically, if the harmfulness determination probability 50 of a section is 100%, that is, if the section is harmful content 40, the section is marked as combined color information of R=255, G=0 and B=0 of 401, that is, red. In contrast, if the harmfulness determination probability 50 of a section is 0%, that is, if the section is harmless content 30, the section may be marked as combined color information of R=0, G=255 and B=0 of 402, that is, green. Meanwhile, if the harmfulness determination probability 50 of a section is 50%, the section may be marked as combined color information of R=G=B=255 of 403.

Furthermore, assuming that the harmfulness determination probability 50 is p, if 50%<p<100%, a corresponding section may be marked as combined color information (third color information) of R=255,

$$G = B = [ 255 \times \frac{( 1 - p ) \times 100}{50} ]$$

of 404. If 0%<p<50%, a corresponding section may be marked as combined color information (fourth color information) of G=255,

$$R = B = [ 255 \times \frac{p \times 100}{50} ]$$

of 405.

FIG. 5 is a diagram schematically illustrating a probability-based multi-category harmfulness map that is generated by the apparatus for generating harmfulness maps according to the embodiment of the present invention.

Referring to FIG. 5, a harmfulness map that is generated using the configuration of graphical information, like that of FIG. 4, is shown. In FIG. 5, a harmfulness map 20 is generated based on harmfulness determination probabilities 50 that are determined by the apparatus for generating harmfulness maps 100. If the harmfulness determination probabilities 50 that are determined by the apparatus for generating harmfulness maps 100 are as shown in FIG. 5, the harmfulness map 20 is generated, as follows. When the harmfulness determination probability 50 is very high (harmful) or very low (harmless), the corresponding color information of the harmfulness map is marked as a color having the same hue and high saturation. In contrast, if the harmfulness determination probability 50 is intermediate (around 50%), the saturation of corresponding color information is low and a user may reconsider the results of the determination of this section. That is, the probability-based multi-category harmfulness map provides more information than the two-category harmfulness map and therefore allows a user to take additional measures, thereby preventing erroneous processing from being taken due to the error of the determination.

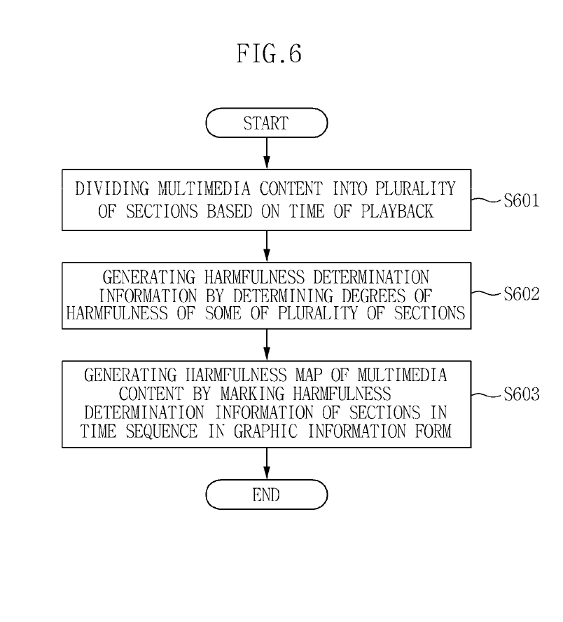

FIG. 6 is a flowchart illustrating a flowchart illustrating a method of generating harmfulness maps according to an embodiment of the present invention.

The method of generating harmfulness maps, which is shown in FIG. 6, is illustrated merely as an embodiment. Accordingly, the respective steps shown in FIG. 6 are not essential steps, and some steps may be modified, added or deleted as needed.

Referring to FIG. 6, when the method of generating harmfulness maps according to an embodiment of the present invention begins, multimedia content is divided into a plurality of sections based on the time of playback at step S601. This is the step of dividing the multimedia content into sections, the harmfulness of each of which will be determined. The criterion for dividing it into sections may be determined in various manners as needed.

Thereafter, harmfulness determination information is generated by determining the degrees of harmfulness of some of the plurality of sections at step S602. In this case, it may be possible to generate harmfulness determination information by determining some of the plurality of sections, or to generate harmfulness determination information corresponding to the harmfulness determination probabilities of some of the plurality of sections.

Once the harmfulness determination information has been generated at step S602, a harmfulness map of the multimedia content is generated by marking the harmfulness determination information of the section in the form of graphical information in a time sequence at step S603. Here, the graphical information may be color information that is created by combining colors including red R, green G and blue B.

Since in the method of generating harmfulness maps according to an embodiment of the present invention, the process of generating a harmfulness map is performed in the same manner as that in the apparatus for generating harmfulness maps according to the former embodiment of the present invention shown in FIG. 2, the same description given in conjunction with FIG. 2 is applied unless described otherwise, and therefore a detailed description thereof will be omitted here. In FIG. 6, all the steps of the flowchart shown in FIG. 6 are not mandatory, like those shown in FIG. 2, and therefore some of the steps may be modified, added or deleted in other embodiments.

The above-described method of generating harmfulness maps has been described with reference to the flowchart presented in the drawing. Although the method has been illustrated and described using a series of blocks for the sake of simplicity, the present invention is not limited to the sequence of the blocks. Some blocks may be performed at sequential positions different from those shown in the drawing, or may be performed at the same time. Varieties of branches, flow paths and sequences of blocks, which can bring about the same or similar results, may be implemented. Furthermore, all of the blocks shown to implement the method described in the specification may not be required.

The present invention has the advantage of generating a harmfulness map on which information about the sections of multimedia content corresponding to harmful content and information about the sections of the multimedia content corresponding to harmless content are marked in graphical information form, thereby clearly presenting information about the harmful sections and degrees of harmfulness of the multimedia content and facilitating the management and editing of the harmful sections.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for generating harmfulness maps, comprising:
a harmfulness determination unit for generating harmfulness determination information by determining degrees of harmfulness of some sections of multimedia content based on a time of playback of the multimedia content; and
a harmfulness map creation unit for generating a harmfulness map of the multimedia content by marking the harmfulness determination information of the sections in a time sequence in graphical information form.

2. The apparatus as set forth in claim 1, wherein the graphical information is color information in which colors including red R, green G and blue B have been combined with one another.

3. The apparatus as set forth in claim 2, wherein the harmfulness determination unit generates the harmfulness determination information by determining whether some sections of multimedia content based on a time of playback of the multimedia content are harmful.

4. The apparatus as set forth in claim 3, wherein the harmfulness map creation unit generates the harmfulness map by marking the harmfulness determination information as first color information if this section is harmful and marking the harmfulness determination information as second color information different from the first color information if this section is harmless.

5. The apparatus as set forth in claim 4, wherein the first color information is combined color information of R=255, G=0 and B=0, and the second color information is combined color information of R=0, G=255 and B=0.

6. The apparatus as set forth in claim 2, wherein the harmfulness determination unit generates harmfulness determination information corresponding to harmfulness determination probabilities of some sections of multimedia content based on a time of playback of the multimedia content.

7. The apparatus as set forth in claim 6, wherein the harmfulness map creation unit generates the harmfulness map by:
marking the harmfulness determination information as first color information if a harmfulness determination probability of this section is 100%;
marking the harmfulness determination information as second color information different from the first color information if a harmfulness determination probability of this section is 0%; and
marking the harmfulness determination information as white if a harmfulness determination probability of this section is 50%.

8. The apparatus as set forth in claim 7, wherein the first color information is combined color information of R=255, G=0 and B=0, the second color information is combined color information of R=0, G=255 and B=0, and the white is combined color information of R=G=B=255.

9. The apparatus as set forth in claim 7, wherein the harmfulness map creation unit marks the harmfulness determination information:
if 50%<p<100%, as third color information having a hue identical to that of the first color information and having a saturation lower than that of the first color information, wherein the saturation of the third color information decreases as p decreases; and
if 0%<p<50%, as fourth color information having a hue identical to that of the second color information and having a saturation lower than that of the second color information, wherein the saturation of the fourth color information decreases as p increases,
wherein p is a harmfulness determination probability of the sections.

10. The apparatus as set forth in claim 9, wherein the third color information is combined color information of R=255,
$$G = B = [ 255 \times \frac{( 1 - p ) \times 100}{50} ] ,$$
and the fourth color information is combined color information of G=255,
$$R = B = [ 255 \times \frac{p \times 100}{50} ] .$$

11. A method of generating harmfulness maps, comprising:
dividing multimedia content into a plurality of sections;
generating harmfulness determination information by determining degrees of harmfulness of some of the plurality of sections; and
generating a harmfulness map of the multimedia content by marking the harmfulness determination information of the sections in a time sequence in graphical information form.

12. The method as set forth in claim 11, wherein the graphical information is color information in which colors including red R, green G and blue B have been combined with one another.

13. The method as set forth in claim 11, wherein the generating harmfulness determination information comprises generating the harmfulness determination information by determining whether some sections of the plurality of sections are harmful.

14. The method as set forth in claim 13, wherein the generating a harmfulness map comprises generating the harmfulness map by marking the harmfulness determination information as first color information if this section is harmful and marking the harmfulness determination information as second color information different from the first color information if this section is harmless.

15. The method as set forth in claim 14, wherein the first color information is combined color information of R=255, G=0 and B=0, and the second color information is combined color information of R=0, G=255 and B=0.

16. The method as set forth in claim 11, wherein the generating harmfulness determination information comprises generating harmfulness determination information corresponding to harmfulness determination probabilities of some of the plurality of sections.

17. The method as set forth in claim 16, wherein the generating a harmfulness map comprises generating the harmfulness map by;
marking the harmfulness determination information as first color information if a harmfulness determination probability of this section is 100%;
marking the harmfulness determination information as second color information different from the first color information if a harmfulness determination probability of this section is 0%; and
marking the harmfulness determination information as white if a harmfulness determination probability of this section is 50%.

18. The method as set forth in claim 17, wherein the first color information is combined color information of R=255, G=0 and B=0, the second color information is combined color information of R=0, G=255 and B=0, and the white is combined color information of R=G=B=255.

19. The method as set forth in claim 17, wherein the generating a harmfulness map comprises:
if 50%<p<100%, marking the harmfulness determination information as third color information having a hue identical to that of the first color information and having a saturation lower than that of the first color information, wherein the saturation of the third color information decrease asp decreases; and
if 0%<p<50%, marking the harmfulness determination information as fourth color information having a hue identical to that of the second color information and having a saturation lower than that of the second color information, wherein the saturation of the fourth color information decreases as p increases,
wherein p is a harmfulness determination probability of a section.

20. The method as set forth in claim 19, wherein the third color information is combined color information of R=255,
$$G = B = [ 255 \times \frac{( 1 - p ) \times 100}{50} ] ,$$
and the fourth color information is combined color information of G=255,
$$R = B = [ 255 \times \frac{p \times 100}{50} ] .$$
